(19) United States
(12) Patent Application Publication
(10) Pub. No.: US 2017/0130480 A1
(43) Pub. Date: May 11, 2017

(54) ADJUSTABLE STAKE

(71) Applicant: Craig PERKINS, Irvine, CA (US)

(72) Inventor: Craig PERKINS, Irvine, CA (US)

(21) Appl. No.: 15/296,499

(22) Filed: Oct. 18, 2016

Related U.S. Application Data
(60) Provisional application No. 62/253,510, filed on Nov. 10, 2015.

(51) Int. Cl. E04H 12/22; G09F 7/20; E01F 9/673

(52) U.S. Cl. CPC E04H 12/2215; E04H 12/2269; E04H 12/2284; E01F 9/673; G09F 7/20; G09F 2007/1856

(57) ABSTRACT

An adjustable stake includes a lower pole including a hollow sleeve, an upper pole configured to be inserted into the hollow sleeve coaxially with the lower pole and to rotate freely therein through a 360 degree arc, and a fixing unit disposed on the lower pole to hold the upper pole stationary with respect to the lower pole.

### CROSS-REFERENCE TO RELATED APPLICATIONS

This application claims priority from Provisional Application No. 62/253,510, filed on Nov. 10, 2015, in the United States Patent and Trademark Office, the disclosure of which is incorporated herein in its entirety by reference.

### BACKGROUND OF THE INVENTIVE CONCEPT

Real Estate agents dread the process and logistics of placing directional signs, for example signs indicating Open Houses. These signs are customarily held up on metal stakes which are driven into the ground, and are transported in the Real Estate agent's car to the site. The task of placing these signs requires managing an array of varying sized stakes, often ranging from short (e.g. 29″) light weight stakes to tall (e.g. 49″) heavy duty stakes, since it is never known which size stake will end up being best suited for the desired location. Accommodating the tall stakes often requires the realtor to fold down a passenger seat and shift other surrounding contents in the car in order to fit in the stakes in the trunk or cargo area. This both takes additional time as well as decreases the number of people the car can accommodate. Furthermore, the unique angles and points of the various stakes inevitably get tangled together. As such, the process of finding and setting up the correct stake is time consuming. Moreover, there is always the looming risk of having the numerous oversized sharp stakes puncture or scratch something in the vehicle that would be very expensive to fix or replace. Retrieving stakes that are tangled together can become a tug of war, further adding risk for potential car damage.

Realtors are forced to choose between preset heights of stakes, as well. Currently “adjustable” stakes are provided with preset holes at varying heights which a realtor must manually affix with a bolt and nut. The height and orientation of such a stake is regulated by the preset spacing of the holes, thereby limiting the realtor's ability to adjust the stake to the optimum height or orientation. The process of manually adjusting such a stake is also time consuming, which is a disadvantage when trying to quickly place each directional sign.

In addition, the viewing positions of the current one-dimensional stakes are limited to the precise placement and footprint in which the realtor can physically insert the spikes into the ground, often forcing the agent to bend the stake prongs to align the sign for optimal viewing, risking breakage of the stakes in the process.

### SUMMARY OF THE INVENTION

It is therefore a primary object of the present invention to provide a system and method which improves upon prior art stakes and methodologies and their related drawbacks as described above.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an adjustable stake, including a lower pole including a hollow sleeve, an upper pole configured to be inserted into the hollow sleeve coaxially with the lower pole and to rotate freely therein through a 360 degree arc, and a fixing unit disposed on the lower pole to hold the upper pole stationary with respect to the lower pole.

In an exemplary embodiment, the lower pole includes a primary spike configured to be driven into a surface, the primary spike being coaxial with the lower pole.

In an exemplary embodiment, the lower pole further includes one or more secondary spikes attached to the lower pole by corresponding arms.

In an exemplary embodiment, at least one of the corresponding arms includes a foot pad to drive the lower pole into a surface.

In an exemplary embodiment, the primary spike has a half spade shape.

In an exemplary embodiment, the primary spike includes a hollow portion aligned with the hollow sleeve of the lower pole and configured to receive a portion of the upper pole inserted into the hollow sleeve of the lower pole.

In an exemplary embodiment, the lower pole includes a hole to receive and engage with the fixing device.

In an exemplary embodiment, the upper pole includes a prong bar, the prong bar extending substantially perpendicular to the upper pole.

In an exemplary embodiment, the prong bar includes one or more prongs to support a sign.

In an exemplary embodiment, the lower pole includes a nesting area configured to receive and support the prong bar when the upper pole is inserted into the hollow sleeve of the lower pole.

In an exemplary embodiment, a lower end of the upper pole contacts a lower end of the hollow sleeve of the lower pole when the upper pole is inserted into the hollow sleeve.

In an exemplary embodiment, the upper pole includes a marker to indicate a lower end thereof.

In an exemplary embodiment, the lower pole includes a foot pad to drive the lower pole into a surface.

In an exemplary embodiment, the foot pad includes a spike configured to be driven into the surface.

In an exemplary embodiment, the upper pole includes a round cross-section.

In an exemplary embodiment, the upper pole includes a polygonal cross-section.

In an exemplary embodiment, the upper pole includes a strike point to receive force to drive the adjustable stake into a surface.

In an exemplary embodiment, the stake has a total length which may be adjusted between about 29″ and about 49″ by adjusting the relative position of the upper pole and the lower pole.

The foregoing and/or other features and utilities of the present general inventive concept may also be achieved by providing a method of adjusting a stake, the method including driving the stake into a surface by applying force to a portion of the stake, changing the relative position of an upper pole of the stake relative to a lower pole of the stake, the upper pole being inserted into a hollow sleeve of the lower pole to be rotatable through a 360 degree arc, and fixing the upper pole and the lower pole together with a fixing device.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1C illustrate an adjustable stake at different degrees of extension according to an exemplary embodiment of the present general inventive concept;

FIG. 2A illustrates a side view of an upper pole according to an exemplary embodiment of the present general inventive concept;

FIGS. 2B and 2C illustrate end views of an upper pole according to exemplary embodiments of the present general inventive concept;

FIG. 3A illustrates a cross-sectional side view of a lower pole according to an exemplary embodiment of the present general inventive concept;

FIGS. 3B and 3C illustrate top end views of a lower pole according to exemplary embodiments of the present general inventive concept;

FIG. 4 illustrates a cross-sectional side view of an adjustable stake according to an exemplary embodiment of the present general inventive concept;

FIG. 5 illustrates a side view of an adjustable stake according to an exemplary embodiment of the present general inventive concept;

FIG. 6A illustrates a nesting area according to an exemplary embodiment of the present general inventive concept;

FIGS. 6B-6C illustrate a nesting area and its relationship to the upper pole according to an exemplary embodiment of the present general inventive concept;

FIGS. 7A-7B illustrate strike points on an upper pole according to exemplary embodiments of the present general inventive concept;

FIG. 7C illustrates a strike plate on an upper pole according to an exemplary embodiment of the present general inventive concept; and

FIG. 7D is an enlarged view of the strike plate according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the preferred embodiments. Thus, the terms used herein are defined based on the intended meaning of the terms together with the description throughout the specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to accompanying drawings.

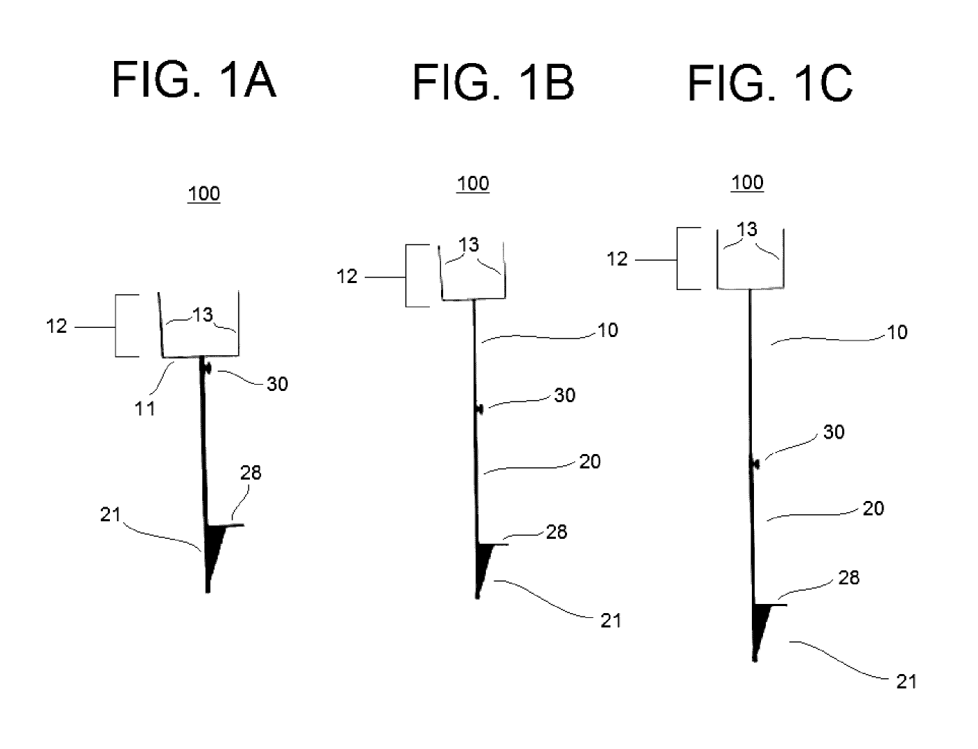

FIGS. 1A, 1B, and 1C illustrate an adjustable sign stake 100 at different degrees of extension according to an exemplary embodiment of the present general inventive concept. For the purposes of this description, “stake” 100 may be used interchangeably with “adjustable sign stake” 100.

As illustrated in FIGS. 1A-1C, a stake 100 according to an exemplary embodiment of the present general inventive concept includes an upper pole 10, a lower pole 20, and a fixing device 30. The upper pole 10 and lower pole 20 may rotate and move relative to one another, and may support an object, e.g., a directional sign to give directions to viewers where to find a house that is for sale. The fixing device 30 may fix the upper pole 10 and lower pole 20 together with respect to their relative positions. The stake 100 may be quickly and easily adjusted to varying heights, for example between about 29″ and about 49″. The range of heights may vary depending on the specific application of the stake 100, and may be any range of heights suited to the purposes described herein. The upper pole 10 may be rotated up to 360° relative to the lower pole 20. As a result, by rotating the upper pole 10 an object, e.g., a sign, supported by the upper pole 10 may be rotated to any angle relative to the lower pole 20 after the stake 100 is placed. As such, the user placing the stake 100 may achieve an optimal viewing angle of a sign supported by the upper pole 10.

The terms “upper” and “lower” are used herein for convenience of description, with reference to the relative positions of the components when the stake is driven into a surface, e.g., the ground. Accordingly, a “lower” pole or “lower” end is closer to the ground than the corresponding “upper” pole or end when the stake 100 is driven into the ground.

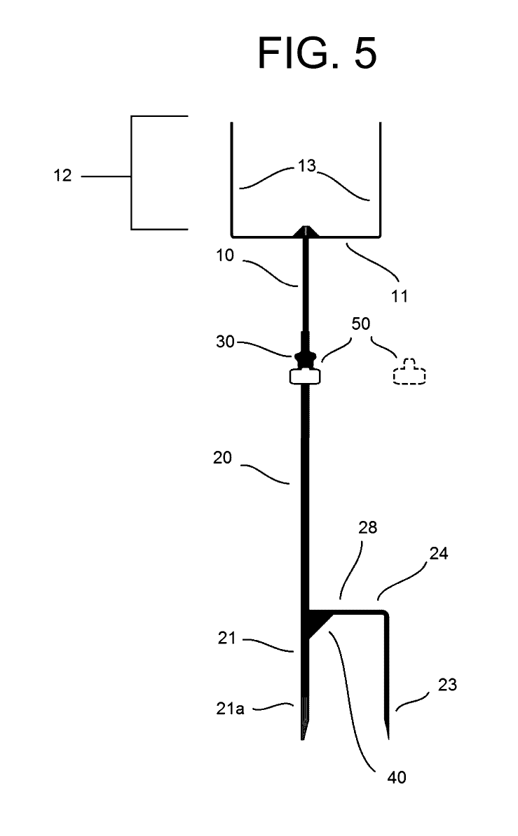

The stake 100 described herein may also include an ID tag 50 (illustrated in FIG. 5) for both unique visibility and personalized identification, memorializing ownership to minimize theft and separate from other surrounding stakes. The ID tag 50 may be color-coded as desired by an individual user. The ID tag 50 may be, for example, a clip which may be attached to any location on the stake 100, or a tag that may hang from the fixing device 30 which holds the upper pole 10 and lower pole 20 together.

The exemplary embodiment of the ID tag 50 illustrated in FIG. 5 is separable from the stake 100. In another exemplary embodiment the ID tag 50 may be integrated with the stake 100, for example being included in fixing unit 30. Such an integrated ID tag 50 may not be removed from the stake 100, and therefore will identify the owner of stake 100 in the event stake 100 is stolen. In an exemplary embodiment of the present general inventive concept, the ID tag 50 may include a location tracker e.g., an ID chip accessory, in order to keep track of the location of the stake 100, for example if multiple stakes 100 are deployed or a stake 100 is stolen.

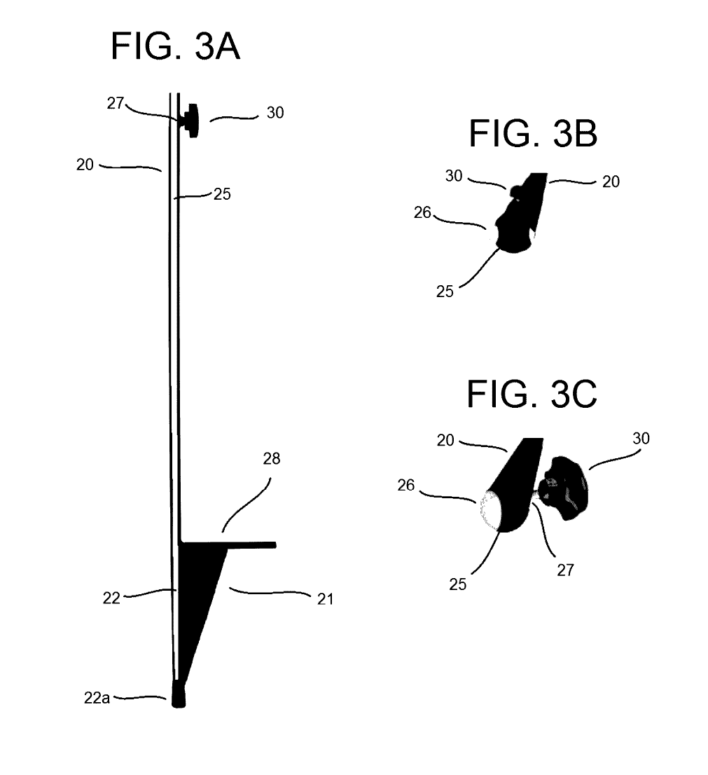

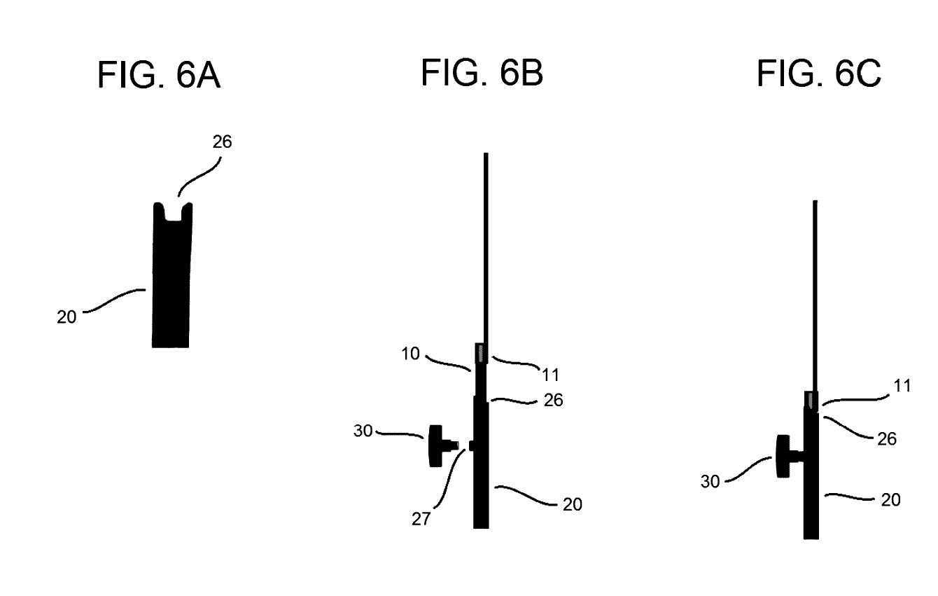

The stake 100 is preferably made of one or more corrosion-resistant materials, such as, for example, powder-coated steel, galvanized steel, stainless steel, and/or plastic. According to an exemplary embodiment of the present general inventive concept, the upper pole 10 may be made of powder-coated steel, the lower pole 20 may be made of galvanized steel, and the fixing device 30 may include, for example, a plastic knob which is attached to a stainless steel screw. Hole 27, illustrated in FIGS. 3C and 6B and described in detail infra, which is configured to engage with the fixing device 30, may optionally be made of stainless steel as well. According to an alternative exemplary embodiment of the present general inventive concept, the upper pole 10 and lower pole 20 may be made of plastic.

In an exemplary embodiment of the present general inventive concept, the stake 100 may be a pole-and-sleeve arrangement in which at least one of the upper pole 10 and lower pole 20 includes a hollow portion which may accommodate the other pole, such that the two poles 10 and 20 are coaxial with respect to each other. For example, the upper pole 10 may be inserted into a hollow sleeve 25 of the lower pole 20, so that the upper pole 10 and lower pole 20 may move relative to one another. It will be understood that any similar configuration may also be used according to the present general inventive concept. For example, the lower pole 20 may instead be inserted into the upper pole 10. Furthermore, the present general inventive concept is not limited to a pole-and-sleeve arrangement. For example, the upper pole 10 and lower pole 20 may be positioned alongside and parallel to each other and held together with the fixing device 30.

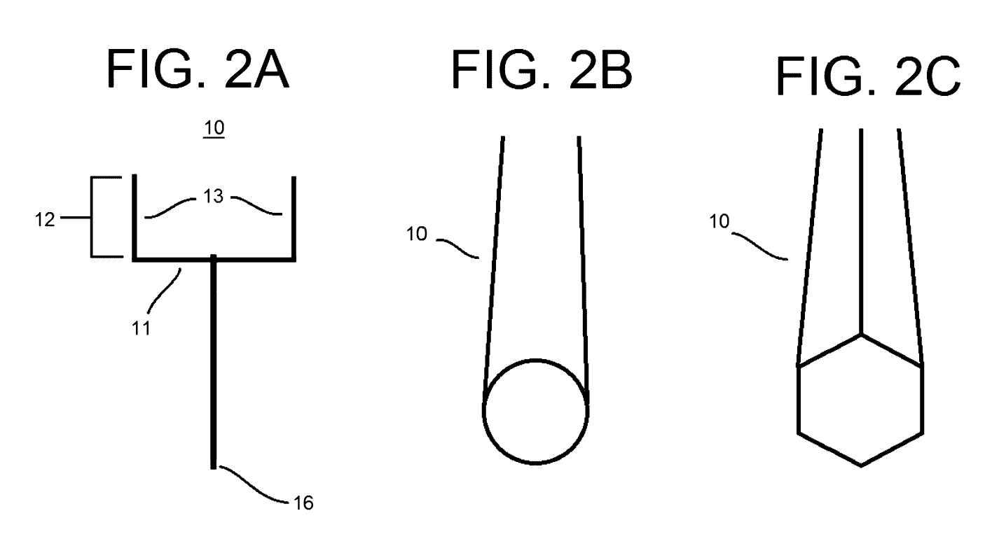

Exemplary embodiments of the upper pole 10 are illustrated in detail in FIGS. 2A-2C. The upper pole 10 may be hollow, partially hollow, or solid in construction. The upper pole 10 may include a prong bar 11 at one end thereof to support a holding portion 12. The holding portion 12 may include one or more prongs 13 to hold a sign. As illustrated for example in FIGS. 2A-2C, the prong bar 11 may extend in a direction substantially perpendicular to the upper pole 10, such that if the upper pole 10 is supported in a vertical orientation, the prong bar 11 is horizontal. Furthermore, the prong(s) 13 may extend in a direction substantially perpendicular to the prong bar 11, such that the prong(s) 13 are substantially parallel to the upper pole 10.

As illustrated in FIG. 2A, a lower end of the upper pole 10, defined herein as the end opposite the holding portion 12, may include a marker 16 to indicate the end of the upper pole 10. This marker 16 may be a physical mark or a color-coded portion to facilitate the combination of the upper pole with the lower pole. This marker 16 may also be referred to as an “end marker” or “height warning label.” The marker 16 may be color-coded or scored to distinguish it from the rest of the upper pole 10. In a pole-and-sleeve arrangement in which the upper pole 10 is inserted into a hollow sleeve 25 of the lower pole 20, for example, a marker 16 at the lower end of the upper pole 10 may help a user more easily align and insert the upper pole 10 into the lower pole 20. While the upper pole 10 and lower pole 20 are assembled, this marker 16 may also alert a user that the stake 100 has telescoped too far. For example, if a color-coded marker 16 is visible, the user is made aware that the upper pole 10 will separate from the lower pole 20 if it is pulled out any further. The marker 16 may be, e.g., 1.5″ in length, but the size of the marker 16 may be any size suited to the purposes described herein.

Exemplary embodiments of the lower pole 20, which may also be called the lower base, are illustrated in detail in FIGS. 3A-3C. FIG. 3A is a cross-sectional side view of the lower pole 20 according to an exemplary embodiment, whereas FIGS. 3B-3C are top end views of the lower pole 20 according to exemplary embodiments of the present general inventive concept.

As illustrated for example in FIG. 3A, the lower pole 20 may include a primary spike 21 formed at a lower end of the lower pole 20 and coaxial with the main body of lower pole 20. According to an alternative exemplary embodiment of the present general inventive concept illustrated at FIG. 5, the lower pole 20 may include one or more secondary spikes 23 attached to the lower pole 20 via one or more arms 24. The primary spike 21 may include a hollow portion 22 which is aligned with the hollow sleeve 25, or alternatively may be solid. Similarly, spike(s) 23 may be solid or hollow, according to the particular exemplary embodiment.

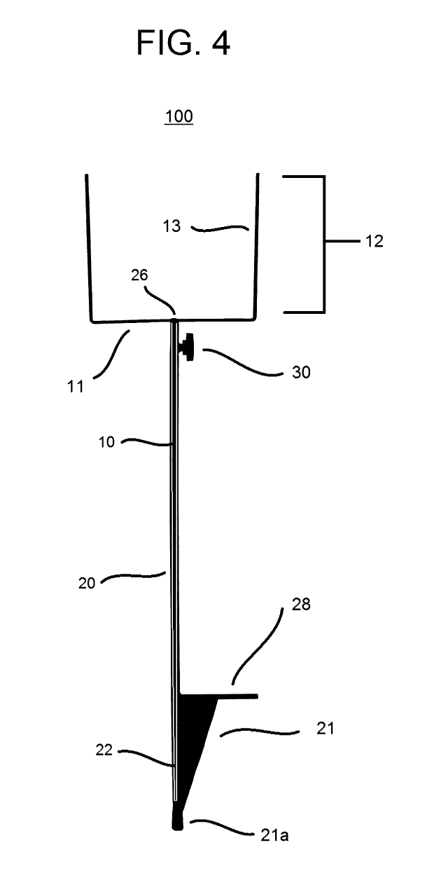

The primary spike 21 and any secondary spikes 23 may have any shape suitable to be driven into a surface, e.g. soil or similar material, to support the stake 100. This may be, e.g., a sharp metal tip, an auger tip, a half spade tip, and so on. A half spade tip, illustrated for example in FIGS. 3A and 4, widens along one side of the lower pole 20, and so simultaneously is suitable to be driven into a surface and also reinforces the lower pole 20, such that it is less likely to bend under the force of being driven into a surface. Furthermore, a half spade spike may have a relatively broad tip 21a, and may be less likely to inadvertently damage objects, e.g., a car seat, than a spike 21 with a narrow tip.

As noted above, the lower pole 20 may further include a hollow sleeve 25 suitable to receive the upper pole 10. The sleeve 25 may extend through the length of the lower pole 20. In the exemplary embodiments of the present general inventive concept illustrated in the cross-sectional views of FIGS. 3A and 4, in a pole-and-sleeve configuration of the stake 100 in which the upper pole 10 is inserted into a sleeve 25 of lower pole 20, a primary spike 21 including a hollow portion 22 may accommodate a portion of the upper pole 10 and allow for more space inside the lower pole 20, thereby allowing the lower pole 20 to accommodate a longer upper pole 10, giving a greater range of extension to the stake 100. Notably, the hollow portion 22 of primary spike 21 does not necessarily extend through the entire length of the primary spike 21. For example, the primary spike 21 may include a solid tip 21a, for example solid steel or reinforced internal ballast, to strengthen the primary spike 21 and assist in penetration of the ground. The solid tip 21a or ballast portion may be any length suited to the purposes described herein, for example 1.125″.

As illustrated in FIGS. 6A-6C, the lower pole 20 may further include a nesting area 26 in an upper end of the sleeve 25 to hold a portion of the upper pole 10 during transport or storage of the stake 100, and thereby keep the upper pole 10 from rotating while the stake 100 is fully collapsed, i.e., the upper pole 10 is fully inserted into the sleeve 25. The nesting area 26 may be, for example, a notch or groove built into the upper end of the lower pole 20 to accommodate the prong bar 11 of the upper pole.

In an exemplary embodiment of the present general inventive concept, the nesting area 26 may accommodate the prong bar 11 of the upper pole 10. This nesting area 26 may securely hold the prong bar 11 in place while the stake 100 is collapsed to its shortest height, thereby keeping the upper pole 10 from rotating relative to the lower pole 20. The nesting area 24 is preferably configured to hold the stake 100 in a substantially flat configuration while the stake 100 is fully collapsed. For example, if the lower end of the lower pole 20 includes one or more horizontal arms 24 supporting one or more secondary spikes 23, the notch or groove of the nesting area 26 may be parallel to these arms 24, so that the prong bar 11 and holding portion 12 of the upper pole 10 are held parallel to the arm(s) 24 and the stake 100 may therefore lie flat while fully collapsed. Exemplary embodiments of the collapsed state of the stake 100 are illustrated in FIGS. 4, 6C, and 7A. The fixing device 30 may also be tightened to hold the stake 100 in the collapsed position. This configuration allows for easy transportation of the stake 100, minimizing damage (e.g., bending or breaking) or entanglement of the spikes 21 and 23 with holding portion 12 of the stake 100 during transport, especially if multiple stakes 100 are being transported together.

The nesting area 26 may be any size suited to the purposes described herein. The nesting area 26 may be for example 0.25″ deep, such that the prong bar 11 nests 0.125″ within the nesting area. Furthermore, as illustrated in FIG. 6A, the nesting area 26 may be centered in the lower pole 20, or as illustrated in FIGS. 6B-6C, it may be offset, being a notch on one side of the lower pole 20.

The upper pole 10 may have a length of, e.g., 28″ including the holding portion 12, and the lower pole 20 may have a length of, e.g., 23″ including the primary spike 21 and any secondary spikes 23. If the lower pole 20 includes both a sleeve 25 and a hollow portion 22 of a primary spike 21, the sleeve 25 and hollow portion 22 may have a total combined length of, e.g., 21.875″. However, it will be understood that these lengths may be adjusted according to the specific application of the stake 100, and still provide the intended applications described herein. In an exemplary embodiment of the present general inventive concept, the lengths of the upper and lower poles 10 and 20 are such that when the upper pole 10 is fully inserted into the hollow sleeve 25 of the lower pole, a lower end of the upper pole 10 rests on the bottom of sleeve 25 or hollow portion 22, while the prong bar 11 of the upper pole 10 rests in the nesting area 26, as illustrated for example in FIGS. 4 and 6C. In an alternative exemplary embodiment, when the upper pole 10 is fully inserted into the hollow sleeve 25, a lower end of the upper pole 10 does not reach the bottom of sleeve 25 or hollow portion 22.

Exemplary embodiments of the fixing device 30 are illustrated in detail in FIGS. 3A-C and 6B-6C. The fixing device 30 may be, for example, a quick-release lock, clamp, screw, thumb knob, or other adjustable/removable fastener which holds the poles 10 and 20 together in a fixed configuration. The fixing device 30 may be configured to affix the upper pole 10 to the lower pole 20, for example by pressing the two poles 10 and 20 together such that friction holds them in place. This fixing device 30 may hold the upper pole 10 and lower pole 20 together at any point in this fashion, and thereby allows an infinite degree of freedom in adjusting the relative positions of the upper pole 10 and lower pole 20. The fixing device 30 may be loosened such that it does not interfere with the rotation of the upper pole 10 relative to the lower pole 20, and so also allows the upper pole 10 to be rotated to any desired angle. The fixing device 30 may also be tightened to hold the poles 10 and 20 in place. The fixing device 30 may also include the ID tag 50 noted above, or the ID tag 50 may be separately attached to the fixing device 30 once the upper and lower poles are fixed in place.

According to the exemplary embodiment of the present general inventive concept illustrated in FIG. 3A, the fixing device 30 may be a T-shaped thumbscrew, to allow a user significant leverage to loosen and tighten the fixing device 30 even under adverse conditions, e.g., cold or damp conditions which may cause increased friction between components of the stake 100. In an exemplary embodiment of the present general inventive concept illustrated in FIGS. 6B-6C, the fixing device 30 may be inserted into a hole 27 in the lower pole 20. The hole 27 may be configured to engage with the fixing device 30, to hold the fixing device 30 in place and enable the fixing device 30 to be loosened and tightened to respectively release and hold the poles 10 and 20. The hole 27 may include, for example, a nut welded to the lower pole 20 to engage with screw threads on the fixing device 30. This nut may be, for example, stainless steel. The fixing device 30 may pass through the hole 27 and contact the upper pole 10 after the upper pole 10 is inserted into the sleeve 25. The fixing device 30 may be tightened against the upper pole 10 and therefore hold the upper pole 10 in place with friction.

The upper pole 10 may have a circular or polygonal cross-section, as illustrated in FIGS. 2B and 2C. A circular cross-section (illustrated in FIG. 2B) allows the upper pole 10 to rotate freely within sleeve 25, such that the upper pole 10 may move between an infinite number of angles relative to the lower pole 20 and be fixed in place with the fixing device 30. A polygonal cross-section (illustrated in FIG. 2C), for example square or hexagonal, may allow the upper pole 10 to more solidly engage with the fixing device 30, allowing the stake 100 to more stably resist external forces, for example wind force upon a sign supported by the stake 100.

As illustrated for example in FIGS. 3B-3C, the lower pole 20 may have a round cross-section, to allow the upper pole 10 to rotate freely within the sleeve 25.

The lower pole 20 may further include a foot pad 28 configured to be struck, e.g. with a mallet or a user's foot, to drive the stake 100 into the ground. The foot pad 28 may be included at, for example, a portion of the lower pole 20 near the primary spike 21, to allow a user to more easily put their foot on the foot pad 28.

In an exemplary embodiment of the present general inventive concept, the foot pad 28 may be integrated with the primary spike 21. See for example FIG. 3A, illustrating a half spade primary spike 21 integrated with the foot pad 28. This integrated design would allow the force applied to the foot pad 28 to be more directly applied to the spike 21, and thereby to driving the spike 21 into the ground. Furthermore, a spike 21 integrated with the foot pad 28 in this way serves to reinforce the lower pole 20, and helps prevent the foot pad 28 or the lower pole 20 from deforming due to the force applied to the foot pad 28.

According to an exemplary embodiment of the present general inventive concept, if the lower pole 20 includes one or more secondary spikes 23, a horizontal arm 24 supporting one of the spikes 23 could include the foot pad 28 to help drive the lower pole 20 into the ground.

The foot pad 28 may be relatively small, e.g., 1 square inch, to accommodate a tool such as a mallet's head, or the foot pad 28 may be relatively long, for example 0.25″ by 3.5″, to accommodate a user's foot. Other options may include a combined long and wide style, for example 2″ by 3″.

Since the stake 100 may be adjusted in height, there is no longer a need for Real Estate agents and other users to carry multiple different sizes of stakes when setting up directional signs. Users may carry any number of stakes 100 according to the present general inventive concept and adjust each stake as necessary. Furthermore, the stake 100 may be compacted down to its minimum height to be easily stored, for example to fit into any car's trunk. This compacting feature may minimize damage to the vehicle or its contents (scratches, punctures, etc.), as well as entanglement with other stakes 100. Furthermore, the compact size allows users to place the stakes in their vehicle without the need to fold down any passenger seats and shift around surrounding items to accommodate the stakes, making for a tidy and organized car friendly environment.

Since the upper pole 10 can be freely rotated relative to the lower pole 20, even after the stake 100 is positioned (e.g., driven into the ground), the upper pole 10, which may be carrying a sign for example, can still be adjusted for optimum position and visibility of a sign. This may be useful, for example, if the sign includes a directional indicator such as an arrow. By rotating the upper pole 10 after placement, such a directional indicator can be oriented quickly and precisely without having to remove and reposition the stake in the ground.

Furthermore, the upper pole 10 and lower pole 20 may be separable from each other, for example by loosening or removing the fixing device 30 which holds them together. Separated upper and lower poles 10 and 20 may reduce tangled storage and facilitate easy retrieval of the stake 100. For example, the upper pole 10 and lower pole 20 may be stored so that the points of the spikes 21 and 23 are aligned with the holding portion 12, to help keep multiple stakes 100 from getting tangled together. The multi-piece design also allows for easy replacement in the event one part breaks.

Although FIGS. 1A-6C illustrate exemplary embodiments of the present general inventive concept, the inventive concept is not limited only to these exemplary embodiments. Alternatives are described herein for the purposes of examples:

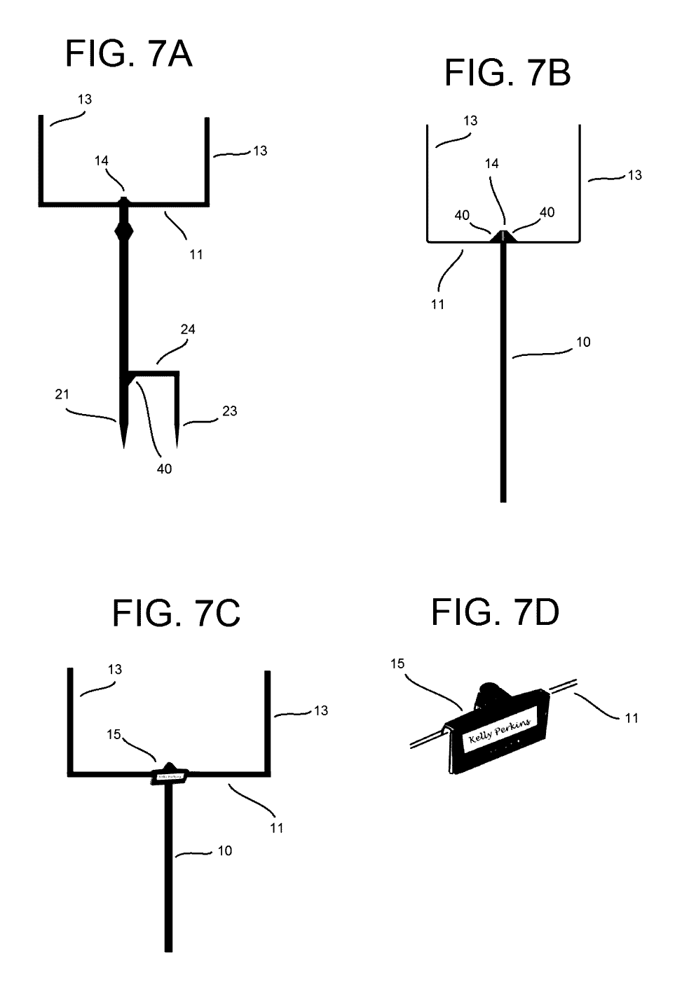

As illustrated in FIGS. 7A-7B, in exemplary embodiments of the present general inventive concept the upper pole 10 may include a strike point 14. This strike point 14 may be formed coaxially with the main body of the pole 10, and may comprise a reinforced portion of the upper pole 10 which may withstand a strike, for example from a mallet, and transfer the force from the strike into the stake 100 without becoming damaged. As illustrated in FIG. 7B, the strike point 14 may include enhanced weld points 40 to reinforce it. The strike point 14 may be positioned, e.g., between two prongs 13 of the holding device 12.

As illustrated in FIGS. 7C-7D, strike point 14 may additionally include a removable/replaceable strike plate 15. The strike plate 15 may further reinforce the stake 100 against damage, for example to prevent cosmetic damage to the stake 100 from being driven into the ground with, e.g., a mallet. The strike plate 15 may be color-coded for easy identification, and may also function as an ID badge, for example naming the realtor owning the stake 100.

Alternatively, the strike plate 15 may be omitted, and instead the strike point 14 of the upper pole 10 may left exposed to be struck with, e.g., a mallet if necessary to drive the stake 100 into the ground. If the strike plate 15 is omitted, the removable ID tag 50 may be attached to the stake 100 after the stake 100 is driven into the ground. The ID tag 50 may be attached to the strike point 14, both to hide the strike point 14 and also to identify the owner of the stake 100.

According to an exemplary embodiment of the present general inventive concept, a lower end of the upper pole 10 does not reach to the bottom of the sleeve 25 when the stake 100 is collapsed. In an alternative exemplary embodiment, the lower end of the upper pole 10 may be in contact with or partially inserted into the primary spike 21 at the bottom of the lower pole 20 while the stake 100 is collapsed. This collapsed state may give the stake 100 a solid construction, thereby allowing a user to more easily drive the stake 100 into the ground without damaging the stake 100 in the process. Accordingly, a user may drive the collapsed stake 100 into the ground with a mallet, for example by striking the strike point 14 or strike plate 15 at the center of the upper pole 10. If the upper pole 10 is in contact with or partially inserted into the primary spike 21, the impact force from the mallet on the upper pole 10, e.g. on the strike point 14 or strike plate 15, may be transferred through the upper pole 10 to the spike 21 at the bottom of the lower pole 20. This transfer of force may drive the stake 100 into the ground without damaging the stake 100.

Furthermore, in exemplary embodiments of the lower pole 20 including a foot pad 28, the foot pad 28 may serve a similar purpose as the strike point 14. That is, the foot pad 28 is configured to receive force from a tool (such as, e.g., a mallet) instead of a user's foot. In an exemplary embodiment of the present general inventive concept in which the foot pad 28 is configured to be struck with a tool, e.g., a mallet, the foot pad 28 may be placed near the upper end of the lower pole 20, to allow a user to more easily strike the foot pad 28 with the tool.

Furthermore, the upper pole 10 and lower pole 20 of the stake 100 may be modular and interchangeable, thereby enabling variable configurations of the stake 100. For example, FIG. 4 illustrates a stake 100 including a lower pole 20 with a single primary spike 21, whereas FIG. 5 illustrates a stake 100 including a lower pole 20 with a primary spike 21 and a secondary spike 23 on an arm 24. The same upper pole 10 may be used in each of these exemplary embodiments, thereby allowing a given upper pole 10, with a given holding device 12, to be matched with a lower pole 20 suited to support it in a given terrain. Similarly, different upper poles 10 with different holding devices 12, for example different prongs 13 configured to accept multiple sized signs and media, may also be used with a given lower pole 20.

As illustrated in FIGS. 5, 7A, and 7B, the stake 100 may also be reinforced, for example by adding reinforced weld points 40 at stress points to minimize errant bending and breakage. For instance, in an exemplary embodiment illustrated in FIG. 7A in which a 2-spike configuration where a horizontal arm 24 supporting a secondary spike 23 extends from the lower pole 20, the horizontal arm 24 may be attached to the lower pole 20 at a joint with a reinforced weld point 40, thereby allowing the arm 24 to better withstand stresses of the spike 23 being driven into the ground, without bending, twisting, or breaking off of the lower pole 20. Similarly, in the exemplary embodiment illustrated in FIG. 7B, the strike point(s) 14 of the stake 100, such as a strike point 14 at a central point on the upper pole 10 may be reinforced to better withstand the insertion and removal of signs or the extra force of the stake being driven into the ground, without deforming. Similarly, the prongs 13 of the upper pole 10 may be reinforced with weld points 40. Any weld points 40 may be, for example, an “angle” weld, reinforcing a corner or other angle of the stake 100.

Furthermore, although the examples described above are of a single-stake design in which the upper pole 10 is parallel or coaxial to the lower pole 20, effectively forming one pole while the stake 100 is assembled, the present general inventive concept is not limited merely to this configuration. For example, two stakes 100, including holding devices 12 which can each hold up one end of a sign, may be used to hold up opposite ends of a sign. In this example, since both stakes 100 are adjustable in both height and rotational angle of the upper pole 10, it becomes relatively simple to align the stakes 100 to support a large sign between them.

Additionally, the lower pole 20 is not limited to only using spikes 21 and 23. The lower pole 20 may have any form suited to supporting the stake 100. For example, in place of spikes 21 and 23, the lower pole may include an optional water/sand filled base or an A-frame stand, which may support the stake 100 on concrete or other surfaces that a spike 21 or 23 cannot be driven through.

Still further, the present general inventive concept is not limited only to supporting signs. In another exemplary embodiment, the upper pole 10 and lower pole 20 may function as an adjustable garden stake to support a trellis instead of a sign, thereby serving, for example, the Home and Garden Industry for growing plants. The specific configuration of the stake 100 may be modified depending on the application. For example, if the stake 100 is being used to support growing vegetation (plants) or a trellis, the holding device 12 of the upper pole 10, or alternatively the fixing device 30 of the stake 100, may include, e.g., a clamp or other fastener to secure a plant or a trellis to the stake.

Still further, although the stake 100 presented herein is of particular use to realtors in displaying, e.g., Open House signs, it is not limited thereto, and may be used to support any manner of signs. For example, a stake 100 according to the present general inventive concept may support garage sale signs, political propaganda, or other signs which benefit from a stake that puts the sign at maximum visibility.

### Example of Use

In an exemplary embodiment of the present general inventive concept including an upper pole 10 inserted into a hollow lower pole 20, the stake 100 may be positioned, for example driven into the ground, by any of the methods described above. Once the stake 100 is securely positioned, for example by having primary spike 21 and optionally secondary spikes 23 on the lower pole 20 driven into the ground, the upper pole 10 may then be adjusted relative to the lower pole 20 to achieve the optimum viewing position. For example, the user may loosen the fixing device 30 and slide the upper pole 10 up from the collapsed position to extend the stake 100 to a desired height. The upper pole 10 may also be rotated in order to achieve an optimum viewing angle of a sign mounted on the upper pole 10. Once adjusted in this manner, the upper pole 10 and lower pole 20 may be secured relative to one another, for example by tightening the fixing device 30, so that the stake 100 may remain in the adjusted configuration.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

What is claimed is:

1. An adjustable stake, comprising:
a lower pole comprising a hollow sleeve;
an upper pole configured to be inserted into the hollow sleeve coaxially with the lower pole and to rotate freely therein through a 360 degree arc; and
a fixing unit disposed on the lower pole to hold the upper pole stationary with respect to the lower pole.

2. The adjustable stake of claim 1, wherein the lower pole comprises a primary spike configured to be driven into a surface, the primary spike being coaxial with the lower pole.

3. The adjustable stake of claim 2, wherein the lower pole further comprises one or more secondary spikes attached to the lower pole by corresponding arms.

4. The adjustable stake of claim 3, wherein at least one of the corresponding arms comprises a foot pad to drive the lower pole into a surface.

5. The adjustable stake of claim 2, wherein the primary spike has a half spade shape.

6. The adjustable stake of claim 2, wherein the primary spike includes a hollow portion aligned with the hollow sleeve of the lower pole and configured to receive a portion of the upper pole inserted into the hollow sleeve of the lower pole.

7. The adjustable stake of claim 1, wherein the lower pole includes a hole to receive and engage with the fixing device.

8. The adjustable stake of claim 1, wherein the upper pole comprises a prong bar, the prong bar extending substantially perpendicular to the upper pole.

9. The adjustable stake of claim 8, wherein the prong bar comprises one or more prongs extending substantially perpendicular to the prong bar to support a sign.

10. The adjustable stake of claim 9, wherein the lower pole comprises a nesting area configured to receive and support the prong bar when the upper pole is inserted into the hollow sleeve of the lower pole.

11. The adjustable stake of claim 10, wherein a lower end of the upper pole contacts a lower end of the hollow sleeve of the lower pole when the upper pole is inserted into the hollow sleeve.

12. The adjustable stake of claim 1, wherein a lower end of the upper pole contacts a lower end of the hollow sleeve of the lower pole when the upper pole is inserted into the hollow sleeve.

13. The adjustable stake of claim 1, wherein the upper pole comprises a marker to indicate a lower end thereof.

14. The adjustable stake of claim 1, wherein the lower pole comprises a foot pad to drive the lower pole into a surface.

15. The adjustable stake of claim 14, wherein the foot pad comprises a spike configured to be driven into the surface.

16. The adjustable stake of claim 1, wherein the upper pole comprises a round cross-section.

17. The adjustable stake of claim 1, wherein the upper pole comprises a polygonal cross-section.

18. The adjustable stake of claim 1, wherein the upper pole comprises a strike point to receive force to drive the adjustable stake into a surface.

19. The adjustable stake of claim 1, wherein the stake has a total length which may be adjusted between about 29″ and about 49″ by adjusting the relative position of the upper pole and the lower pole.

20. A method of adjusting a stake, the method comprising:
driving the stake into a surface by applying force to a portion of the stake;
changing the relative position of an upper pole of the stake relative to a lower pole of the stake, the upper pole being inserted into a hollow sleeve of the lower pole to be rotatable through a 360 degree arc; and
fixing the upper pole and the lower pole together with a fixing device.
